(19) United States
(12) Patent Application Publication
(10) Pub. No.: US 2021/0035209 A1
(43) Pub. Date: Feb. 4, 2021

(54) SYSTEMS AND METHODS FOR MANAGING UNSECURED LENDING TRANSACTIONS

(71) Applicant: ApexLend LLC, Lewes, DE (US)

(72) Inventor: Hyung Myung Peak, Lewes, DE (US)

(73) Assignee: ApexLend LLC, Dewes, DE (US)

(21) Appl. No.: 16/528,501

(22) Filed: Jul. 31, 2019

(51) Int. Cl. G06Q 40/02

(52) U.S. Cl. CPC G06Q 40/025

(57) ABSTRACT

Systems and methods are provided for facilitating and managing unsecured loan products that utilize borrower's existing credit accounts as a modified collateral. In some embodiments, a lender can provide lending products by using customer's existing credit account as a collateral. In some embodiments, a lender may place preauthorization hold on one of customer's existing credit accounts.

### TECHNICAL FIELD

The present disclosure is generally related to financial systems. More particularly, the present disclosure is directed to systems and methods for managing unsecured lending transactions.

### BACKGROUND

Financial institutions such as banks offer a variety of lending products to meet the varying needs of their customers. For example, a financial institution may offer a diverse range of personal lending products including personal, unsecured loans or lines of credit, secured loans or lines of credit (e.g., secured by collateral), and secured credit cards. Each of these various products may address a particular type of financial need or goal.

Typically, secured loans and lines of credit require that the customer have assets and/or existing accounts with the financial institution that may be used as collateral, while personal or unsecured loans and lines of credit typically do not have such requirements. However, secured loans and lines of credit may, however, provide a higher borrowing limit or lower interest rate than personal loans and lines of credit, and secured lines of credit may have higher minimum borrowing requirements than personal lines of credit.

Given the varying features and objectives of each of these lending products, the requirements, borrowing limits and other terms and conditions for each of these products may vary significantly. For example, secured loans and lines of credit may offer lending options to customers without an established credit history, or customers seeking lower annual percentage interest rates or higher borrowing limits. Similarly, unsecured loans may provide customers with good credit history with a revolving line of credit that may be used as a source of funds for managing major or unplanned expenses such as home furnishings or medical expenses.

However, while a typical financial institution may offer a wide range of lending products, the particular combination of features included in these lending products may not be the optimum solution to a particular customer's needs. Accordingly, a customer may be required to sacrifice desired features in order to obtain the desired pricing and payment terms and vice versa. There is an ongoing need for improved systems and methods to allow financial institutions to provide lending products that meet the varying needs of their customers.

### SUMMARY

In accordance with one or more embodiments, various features and functionality can be provided to enable or otherwise facilitate managing unsecured loan products.

In some embodiments, a lender can provide lending products, for example, personal unsecured loans, lines of credit, and/or others such products, to a customer by placing a preauthorization hold on one of customer's existing credit accounts. In this way, the unsecured loan can be issued using existing credit account as a collateral.

In some embodiments, an unsecured loan management system may be utilized by customers wishing to obtain an unsecured loan that utilizes a modified collateral. For example, customers may initiate an unsecured loan request process by requesting an unsecured loan via the unsecured loan management system.

In some embodiments, the unsecured loan management system may be configured to generate a loan application entry form configured to receive user input during an unsecured loan request process. In some embodiments, user input received by the unsecured loan management system may include customer information, information related to customer's existing credit accounts, customer's home ownership information, customer's employment information, customer's current monthly payment information, and/or other similar user input.

In some embodiments, the borrower may provide information related to a revolving credit account the borrower wishes to use as a modified security for the unsecured loan product. In some embodiments, the borrower may provide information related to a revolving credit account the borrower wishes to pay off with the unsecured loan product.

In some embodiments, the unsecured loan management system may determine customer's eligibility for one or more unsecured lending products based on one or more lender provided criteria and/or other parameters.

In some embodiments, the unsecured loan management system may generate a loan selection form configured to receive user input during the unsecured loan request process. For example, details and/or features related to one or more unsecured loan products may be provided to the customer. In some embodiments the customer may select a particular unsecured loan products by providing user input.

In some embodiments, the unsecured loan management system may process a pre-authorization associated with the modified collateral for the unsecured loan with a borrower's revolving credit account, as alluded to above. In some embodiments, the unsecured loan management system may process the pre-authorization as a payment in the event the periodic payment, as described above, cannot be processed.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 illustrates an unsecured loan management system comprising an unsecured lending platform, according to an implementation of the disclosure.

FIG. 2 illustrates a loan application screen within the unsecured lending platform of the unsecured management system of FIG. 1, according to an implementation of the disclosure.

FIG. 3 illustrates a loan selection screen within the unsecured lending platform of the unsecured management system of FIG. 1, according to an implementation of the disclosure.

FIG. 4 illustrates a loan information screen within the unsecured lending platform of the unsecured management system of FIG. 1, according to an implementation of the disclosure.

FIG. 5 illustrates loan payment processing performed by the unsecured management system of FIG. 1, according to an implementation of the disclosure.

FIG. 6 illustrates a process for managing unsecured lending products, according to an implementation of the disclosure.

FIG. 7 illustrates an example computing system that may be used in implementing various features of embodiments of the disclosed technology.

### DETAILED DESCRIPTION

Described herein are systems for facilitating consumer lending by providing lending products using a modified collateral requirement. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to above, unlike lenders that offer secured loans which use assets (e.g., property to secure a mortgage) as collateral, lenders that offer unsecured loans do not require any property or other collateral to secure or guarantee the loan. Because nothing specific has been pledged as collateral, lenders assume more risk when offering unsecured loans which in turn translate to less favorable terms to a customer including, for example, higher interest rates or more stringent loan qualifications.

One type of conventional, unsecured borrowing that customers often use includes utilizing a revolving credit account. However, borrowing a lump sum from a revolving credit account is often accompanied at unfavorable terms (e.g., high interest rates and/or limited pay-off duration). Accordingly, systems and methods are provided to allow customers to obtain unsecured loans having more favorable terms than conventional unsecured loans by using a modified collateral requirement. In particular, and as described further in detail below, the present embodiments utilize customer's existing revolving credit accounts as a form of collateral. By utilizing this type of modified collateral, allows lenders to offer a wider range of lending products providing customers with more lending options to select from, often at more favorable terms (i.e., closer to secured loans, as explained above).

In accordance with various embodiments, a lender can provide lending products, for example, personal unsecured loans, lines of credit, and/or others such products, to a customer by placing a preauthorization hold on one of customer's existing credit accounts. In this way, the unsecured loan can be issued using existing credit account as a collateral. Furthermore, by utilizing existing credit accounts as a modified form of collateral, total credit available to the customer does not increase, and debt-to-income ratios will decline due to lower interest rates. That is, the credit available to the customer is not affected when existing credit accounts are utilized as a modified collateral. Accordingly, this type of lending allows the customer to maintain the same debt balance and avoid a potentially negative impact to their overall credit.

Further still, because the customer has already been underwritten by an existing credit company, any additional underwriting performed by the lender of the present embodiments is lessened and/or obviated, thereby reducing any associated underwriting costs. In some embodiments, an unsecured loan can be issued using customer's existing lines of credit (distinct from revolving credit accounts) as a modified collateral. For example, an existing home equity line of credit or HELOC and/or a corporate line of credit may be used as a modified collateral. By using this modified form of collateral, the customers can borrow funds without impacting their overall credit and/or having to go through an extensive underwiring process, as alluded to above with respect to existing credit accounts. By virtue of using existing credit accounts (i.e., either revolving credit account or existing lines of credit) issued by reputable third-party lenders as a modified collateral, the lender is able to streamline the lending process. For example, the lender can to interact with customers entirely online without increasing its risk while keeping the loan processing costs low.

According to various exemplary embodiments, an unsecured lending product may be provided to individuals, customers, account holders or other types of borrowers attempting to apply for lending products from a lender. In some embodiments, a customer may be presented with an application form that may be to apply for an unsecured lending product offered by lender. For example, the customer may enter, via the application form, loan application information, including information regarding the customer's personal information, customer's financial information, such as customer's credit information, current outstanding liabilities, and available credit cards that may be used as a collateral, and/or other such information. The loan application information received from the customer may be evaluated against one or more lending criteria categories across multiple types of lending products. The lender may then provide the customer with a number of selectable lending products based on the evaluation of the loan application data. For example, lending product may be a personal loan or a line of credit, each lending product having varying terms (e.g., annual percentage rate and recurring periodic payment amount). Upon receiving customer's selections of the type of lending product, the lender may generate the lending product details, including, for example, information regarding the type of lending product selected, an annual percentage rate and a recurring periodic payment amount for the amount financed via the lending product, and a preauthorized credit account amount held as a security. It should be noted, that the term “credit account”, as used herein, can refer to a revolving credit account issued by a financial institution.

Another aspect of the present embodiments disclosed herein is the processing of recurring customer payments to pay back the unsecured lending products issued to them. In particular, upon the customer obtaining the unsecured loan from the lender, the recurring periodic payments may be processed as conventional electronic payment transactions. Transaction processing of electronic payments can include both an authorization side and a clearance side. The authorization side may involve the process of confirming that a borrower has a sufficient line of credit to cover a proposed payment. The clearance side of the transaction may involve the process of moving funds from an issuing bank to a an acquiring lender bank. As alluded to above, in addition to processing transactions associated with recurring payments, a hold may be placed on an amount held as security for the loan by pre-authorizing that amount with customer's one or more existing credit accounts. In some embodiments, a hold may be placed on an amount held as a security for the loan by pre-authorizing that amount with customer's one or more existing home equity line of credit accounts and/or one or more corporate line of credit accounts. In yet other embodiments, post-dated checks on the home equity line of credit account and/or the corporate line of credit account can be utilized when placing a pre-authorization hold. For example, as the recurring payment on the loan are processed successfully, the checks are discarded.

It should be noted that the term “authorization” and “pre-authorization” may have a distinct definition in the context of electronic transactions. For example, the term authorization can refer to (as described above) the process by which issuing bank approves or declines a transaction based on the availability of the requisite funds (in the case of bank funds) and/or requisite credit availability (in the case of available credit). Pre-authorization can be accomplished by placing a temporary hold for a particular period for a particular amount of a customer's funds with the credit account issuing bank. The pre-authorization amount will be unavailable to the customer until the pre-authorization period expires. However, no funds are actually transferred during a pre-authorization takes place. Pre-authorization is often used to guarantee that funds are available in the event any charges are incurred (e.g., during a hotel stay or in car rental scenario).

In accordance with various embodiments, authorization and/or pre-authorization processes can be considered to be encompassed by the exchange of authorization or pre-authorization information (e.g., authorization or pre-authorization request and/or authorization or pre-authorization responses/approval/decline messaging described herein).

Clearing (which can happen after transmission of the authorization response if approved) can refer to a process by which issuing bank exchanges transaction information with acquiring bank (also referred to as the merchant or lender bank). Settlement can refer to a process by which issuing bank exchanges the requisite funds with acquiring bank to complete an approved transaction.

As previously alluded to, authorization and pre-authorization procedures are important in the context of unsecured lending products using a modified collateral. For example, without the ability to pre-authorize the amount with a credit issuing bank and/or process the pre-authorized amount as a transaction in the event of failure to clear and settle the monthly payment, conventional unsecured lenders cannot offer loans with favorable terms, i.e., similar to secured loans.

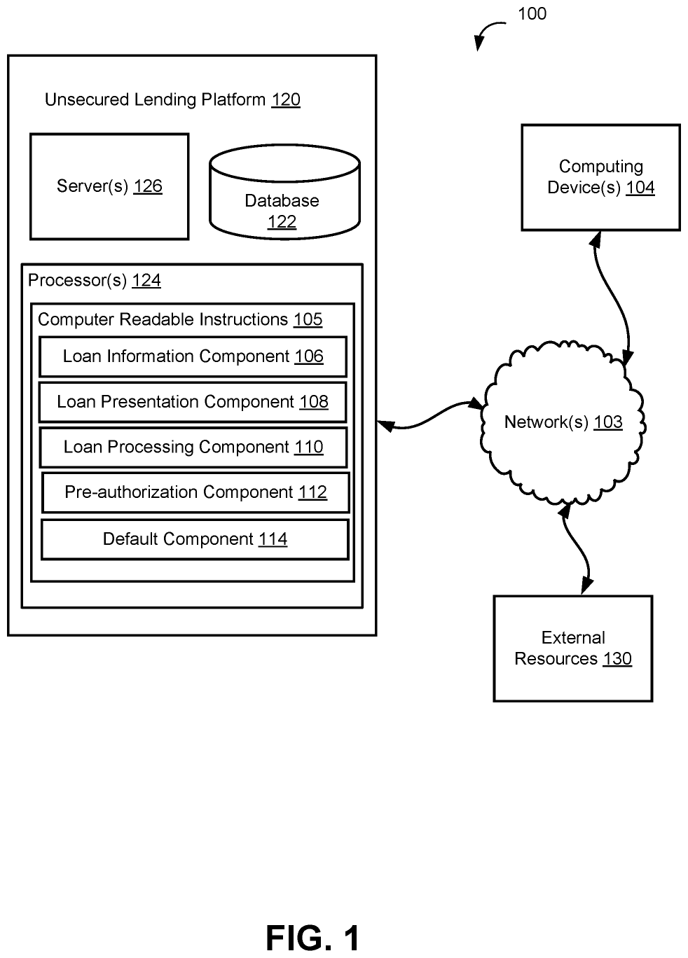

FIG. 1 illustrates an example unsecured loan management system 100 configured in accordance with one embodiment. Unsecured loan management system 100 or components/features thereof may be implemented in combination with, or as an alternative to, other systems/features/components described herein, such as those described with reference to other embodiments and figures. The unsecured loan management system 100 may additionally be utilized in any of the methods for using such systems/components/features described herein. Unsecured loan management system 100 may also be used in various applications and/or permutations, which may or may not be noted in the illustrative embodiments described herein. For instance, unsecured loan management system 100 may include more or less features/components than those shown in FIG. 1, in some embodiments. Moreover, unsecured loan management system 100 is not limited to the number of components, etc. specifically shown in FIG. 1, although one or more aspects of unsecured loan management system 100 may have particular component constraints in certain embodiments, as these one or more aspects may impact the detection capabilities of unsecured loan management system 100.

In some embodiments, and as shown in FIG. 1, the unsecured loan management system 100 may comprise an unsecured lending platform 120 configured to manage unsecured loans by using a modified collateral requirement, as alluded to above. The unsecured lending platform 120 may include one or more servers 126. For example, the server 126 may be configured to communicate with one or more client computing devices 104 according to a client/server architecture. Users of unsecured loan management system 100 (e.g., borrowers) may access the unsecured lending platform 120 via client computing devices(s) 104. Server 126 may include one or more processors 124 configured to execute one or more computer readable instructions 105. In some embodiments, the computer readable instructions 105 may include one or more computer program components. For example, computer program components may include one or more of a loan information component 106, a loan presentation component 108, a loan processing component 110, a pre-authorization component 112, a default component 114, and/or other such components.

In some implementations, unsecured lending platform 120, client computing devices 104, and/or external resources 130 may be operatively linked via one or more electronic communication links. For example, such electronic communication links may be established, at least in part, via a network 103 such as the Internet and/or other networks. It will be appreciated that this is not intended to be limiting, and that the scope of this disclosure includes implementations in which server(s) 126, client computing device(s) 104, and/or external resources 130 may be operatively linked via some other communication media.

In some embodiments, external resources 130 may comprise one or more credit repositories provided by one or more credit reporting agencies (i.e., credit bureaus). The credit repository may include one or more servers, processors, and/or databases that can store credit related information, e.g., credit history, credit score or a credit report provided by one or more external credit reporting bureaus (e.g., Equifax). The credit related information may be used by unsecured lending platform 120 to determine loan eligibility.

In some embodiments, as alluded to above, a borrower may access unsecured lending platform 120 via a client computing devices 104 via a user interface (not shown). For example, client computing device 104 may be a desktop computer or a mobile device (e.g., a tablet computing device a cellular phone). The interface may be used to receive and transmit information to unsecured lending platform 120 via a communication network 103, as explained above.

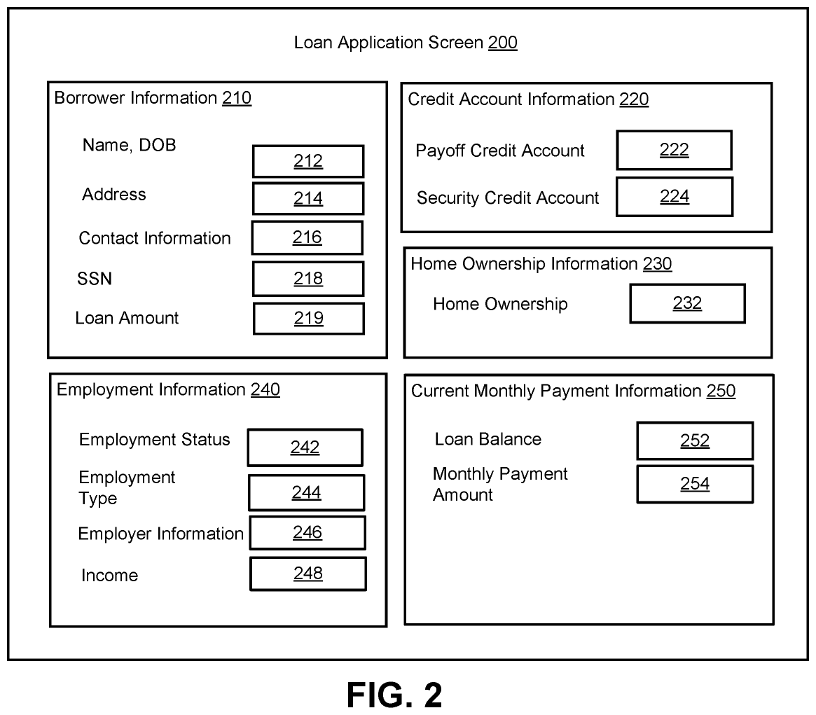

In some embodiments, the loan information component 106 may be configured to generate a loan application entry form configured to receive user input during an unsecured loan request process. For example, and as illustrated in FIG. 2, a loan application screen 200 may be configured to receive borrower information 210, credit account information 220, home ownership information 230, employment information 240, current monthly payment information 250, and/or other similar borrower input. In some embodiments, the loan information component 106 may be configured to determine user's eligibility for one or more unsecured lending products based on one or more lender provided criteria and/or other parameters (e.g., system generated parameters and so on).

In some embodiments, loan information component 106 may be configured to receive borrower information 210 including borrower biometric information. For example, a borrower may provide name and date of birth via input field 212 within loan application screen 200. Similarly, borrower may provide address, contact information, and social security number via input field 214, 216, and 218, respectively. In some embodiments, the borrower may be required to provide an installment amount via an input field 219. For example, the loan amount may the amount the borrower wishes to borrow from a financial institution as an unsecured loan, as alluded to above. Alternatively, the loan amount may be an installment loan payment that the borrower wishes to pay in order to pay off their outstanding revolving credit account balance. That is, the installment loan payment will be used to determine the loan amount.

In some embodiments, and as alluded to above, the loan information component 106 may be configured to determine whether a user is eligible for one or more unsecured lending products offered by a lender based on the received user input. For example, upon determining that the loan amount entered via the input field 219 is greater than a loan amount specified by a lender, the loan information component 106 may determine that the borrower is not eligible for any of the loans offered by the lender and may prevent the borrower from entering any additional information thereby ending the receipt of user input. Alternatively, upon determining that the loan amount entered via the input field 219 is less than the loan amount specified by the lender, the loan information component 106 may prompt the borrower to enter additional information, such as credit account information 220, home ownership information 230, employment information 240, current monthly payment information 250, and/or other similar borrower input.

In some embodiments, loan information component 106 may be configured to receive credit account information 220 including information related to existing revolving credit accounts the borrower may have. In some embodiments, the borrower may provide information related to a revolving credit account the borrower wishes to pay off with the unsecured loan product and information related to a revolving credit account the borrower wishes to use as a modified security for the unsecured loan product, as explained earlier. For example, the borrower may provide a type of account (e.g. Visa, Mastercard), an account number, and a balance associated with a revolving credit borrower wishes to pay off account via input field 222 within loan application screen 200. Similarly, the borrower may provide a type of account (e.g. Visa, Mastercard), an account number, and available credit associated with a revolving credit borrower wishes to use a modified security via input field 224.

In some embodiments, upon determining that the balance associated with one or more revolving credit accounts entered via the input field 222 is greater than a loan amount specified by a lender, the loan information component 106 may determine that the borrower is not eligible for any of the loans offered by the lender and may prevent the borrower from entering any additional information thereby ending the receipt of user input. Alternatively, upon determining that the balance associated with one or more revolving credit accounts entered via the input field 222 is less than the loan amount specified by the lender, the loan information component 106 may prompt the borrower to enter additional information, such as home ownership information 230, employment information 240, current monthly payment information 250, and/or other similar borrower input. Additionally, similar determinations may be made by the loan information component 106 with regard to available credit entered via the input field 224. That is, if the available credit entered via the input field 222 is less than a lender specified modified security amount, the borrower may not advance further. In some embodiments, if the available credit entered via the input field 222 is less than the lender specified modified security amount, the borrower may be provided with an option to borrow a lesser amount rather than preventing the borrower from advancing further.

In some embodiments, the loan information component 106 may be configured to receive home ownership information 230 including information related to borrower's home ownership status (e.g., rent or own), and/or additional information related to their home ownership (e.g., mortgage payment information) via input field 232 within loan application screen 200. In some embodiments, upon receiving information indicating that the user is a home owner but does not have a current mortgage associated with their property, the loan information component 106 may determine that the borrower is not eligible for any of the loans offered by the lender and may prevent the borrower from entering any additional information thereby ending the receipt of user input. Alternatively, upon receiving information indicating that the user is a home owner without an active mortgage, the loan information component 106 may be configured to determine that the user is eligible for an unsecured lending product with a higher interest rate than that associated with home owners that have active mortgages associated with the property. In some embodiments, upon receiving information indicating that the user is not a home owner as may be required by the lender, the loan information component 106 may determine that the borrower is not eligible for any of the loans offered by the lender and may prevent the borrower from entering any additional information thereby ending the receipt of user input. Alternatively, upon receiving information indicating that the user is not a home owner, the loan information component 106 may prompt the borrower to enter additional information, such as employment information 240, current monthly payment information 250, and/or other similar borrower input. In some embodiments, upon receiving information indicating user's home ownership status, the loan information component 106 may be configured to determine user's eligibility for a particular unsecured lending product. For example, upon receiving information indicating that the user is not a home owner, the loan information component 106 may be configured to determine that the user is eligible for an unsecured lending product with a higher interest rate.

In some embodiments, the loan information component 106 may be configured to receive employment information 240. For example, the borrower may provide information related to borrower's employment status (e.g., employed or not) entered via input field 242, a type of employment (e.g., contractor, self-employed) entered via input field 244, name, address and other employer-related information entered via input field 246, as well income information (e.g., annual compensation, bonus, etc.) entered via input field 248. In some embodiments, upon receiving information indicating that the user is not employed or if the user's annual income is less than a lender specified income, the loan information component 106 may determine that the borrower is not eligible for any of the loans offered by the lender and may prevent the borrower from entering any additional information thereby ending the receipt of user input. Alternatively, upon receiving information indicating that the user is employed and is receiving income greater than the specified income amount, the loan information component 106 may prompt the borrower to enter additional information, such as current monthly payment information 250, and/or other similar borrower input. In some embodiments, upon receiving information indicating borrower's employment status, the loan information component 106 may be configured to determine borrower's eligibility for a particular unsecured lending product. For example, upon receiving information indicating that the borrower is not employed and/or has income level below a particular level, the loan information component 106 may be configured to determine that the borrower is eligible for an unsecured lending product with a higher interest rate.

In some embodiments, the loan information component 106 may be configured to receive current monthly payment information 250 related to one or more loans and/or revolving credit accounts the user is currently paying. For example, the borrower may provide information related to borrower's one or more existing loans (e.g., auto loan, mortgage, revolving credit account) balance entered via input field 252, and a monthly loan payment type associated with each of the loans entered via input field 254. In some embodiments, the loan information component 106 may determine that the borrower is not eligible for any of the loans offered by the lender based on current monthly information 250 and may prevent the borrower from entering any additional information thereby ending the receipt of user input. For example, loan information component 106 may determine that the borrower's monthly payments associated with one or more existing loans exceed their monthly income. In some embodiments, upon receiving information related to borrower's current monthly payment information, the loan information component 106 may be configured to determine borrower's eligibility for a particular unsecured lending product. For example, upon receiving information indicating that the borrower's monthly payments exceed their monthly income, the loan information component 106 may be configured to determine that the borrower is eligible for an unsecured lending product with higher interest rate. In yet other embodiments, upon receiving borrower's income information, as alluded to above, and borrower's current monthly payment information, loan information component 106 may determine that the borrower's debt-to-income ratio is higher than a lender specified ratio and may prevent the borrower from entering any additional information thereby ending the receipt of user input. In further embodiments, upon receiving borrower's income information and borrower's current monthly payment information, loan information component 106 may determine that the borrower does not meet the ability-to-repay (ATR) requirements and thus is not eligible for any of the loans offered by the lender and may prevent the borrower from entering any additional information thereby ending the receipt of user input.

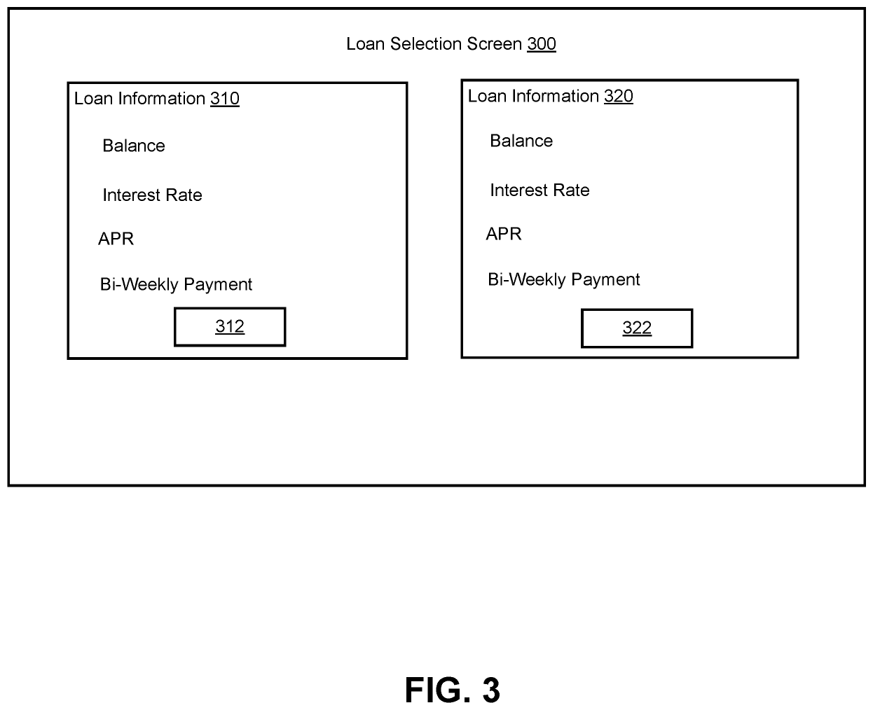

In some embodiments, loan information component 106 may be configured to generate a loan selection form configured to receive user input during the unsecured loan request process. For example, the one or more unsecured loans the borrower wishes to obtain from the lender may include varying terms (e.g., duration of the loan being three, five, seven, ten years and/or other such duration). In some embodiments, and as illustrated in FIG. 3, a loan selection screen 300 may be configured to receive borrower selection in connection with one or more unsecured loans the borrower wishes to obtain from the lender. For example, details and/or features related to an unsecured 3-year loan may be provided via a loan information screen 310 including balance information, interest rate, APR, bi-weekly payment. Similarly, details and/or features related to an unsecured 5-year loan may be provided via a loan information screen 320 including balance information, interest rate, APR, bi-weekly payment. Borrower may select between the two unsecured lending products by providing user input via user selection field 312, 322, respectively.

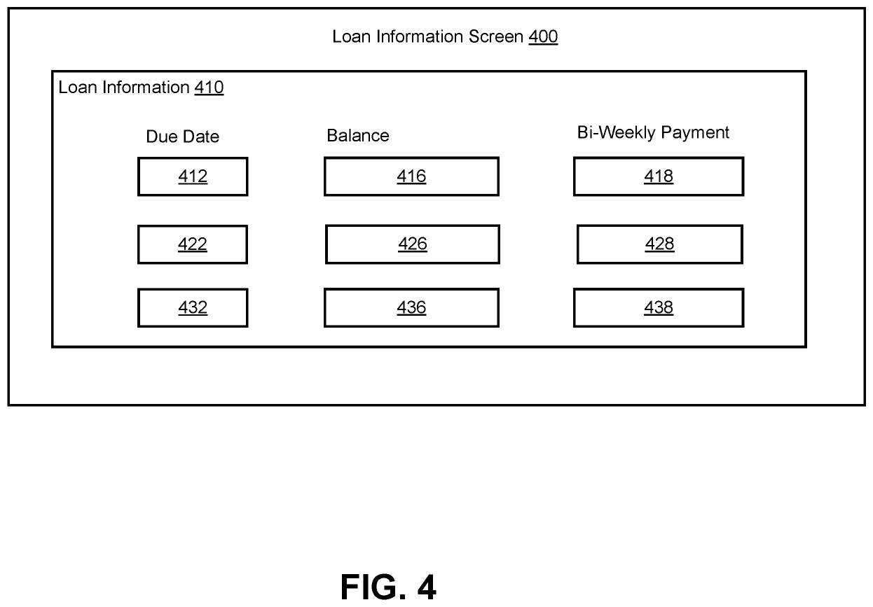

In some embodiments, loan information component 106 may be configured to obtain user input related in connection with one or more unsecured loans the borrower wishes to obtain from the lender, as explained above. Upon receiving the user input, loan presentation component 108 may transmit loan information in connection with one or more unsecured lending products selected by the borrower. For example, and as illustrated in FIG. 4, a loan information screen 400 may be configured to display information related to the one or more unsecured lending products selected by the borrower. In some embodiments, the loan information may include loan payment details such as loan amount, periodic payments associated with repaying the loan, payment due dates, and so on. In some embodiments, loan information may include amortization schedules. For example, loan information 410 may include due dates 412, 422, 432 for each of the bi-weekly payments 418, 428, 438 and the remaining balance of the loan, respectively, after each of the bi-weekly payments 418, 428, 438 was processed.

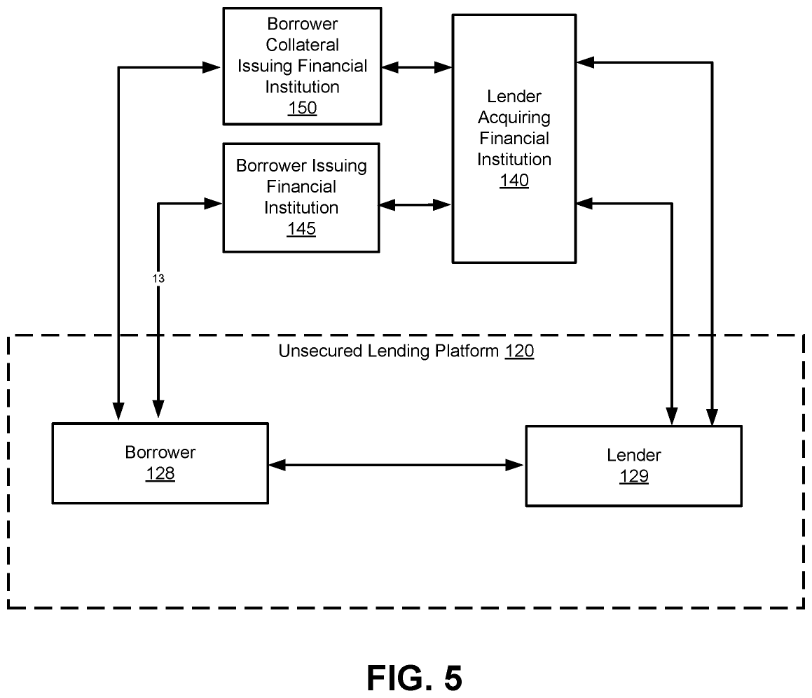

In some embodiments, as alluded to above, unsecured loan management system 100 may be configured to process periodic payments the borrower agreed to pay on the unsecured loan as conventional electronic payment transactions. For example, the periodic payments may be monthly, bi-monthly, bi-weekly payments processed by unsecured loan management system 100. By utilizing a periodic payment that is shorter than the pre-authorization period, such as a bi-weekly payment, the lender is able to hold the authorization after the periodic due date, thus providing the borrower with a grace period. In some embodiments, and as illustrated in FIG. 5, upon the borrower obtaining the unsecured loan from the lender, the periodic payments may be processed by unsecured loan platform 120 of unsecured loan management system 100 illustrated in FIG. 1.

In some embodiments, loan processing component 110 may be configured to process payments between a borrower 128, a borrower issuing financial institution 145, a borrower collateral issuing financial institution 150, a lender 129 and a lender acquiring financial institution 140.

It is understood that prior to the occurrence of such a transaction, borrower 128 has an account with borrower issuing financial institution 145. Moreover, it will be understood that lender 129 has established a relationship with lender acquiring financial institution 140, thereby allowing lender 129 to receive electronic payments as periodic payment on the loan. That is, lender acquiring financial institutions (i.e., banks) and borrower issuing financial institutions may participate in various payment networks (not shown).

Lender acquiring financial institution 140 may transmit transaction information to a clearing system (not shown). In particular, lender acquiring financial institution 140 may send clearing data in a clearing message to a payment network, whereupon the payment network calculates a net settlement position and sends advisement to lender acquiring financial institution 140 and borrower issuing financial institution 145. Borrower issuing financial institution 145 can remit payment to the payment to lender acquiring financial institution 140. Lender acquiring financial institution 140 then pays lender 129 for the periodic payment made by borrower 128, and borrower issuing financial institution 145 bills borrower 128. In some embodiments, the transactions may be fulfilled in a wireless ‘wire transfer’ or ACH (Automated clearing house) in the U.S. or similar environments. In some embodiments, transactions may be fulfilled if certain conditions are met and agreed upon by the sending and/or receiving parties, institutions.

In some embodiments, unsecured loan platform 120 may be configured to process a pre-authorization associated with the modified collateral for the unsecured loan with a borrower's revolving credit account, as alluded to above. In some embodiments, pre-authorization component 112 may be configured to process pre-authorization transactions between borrower collateral issuing financial institution 150 and the lender acquiring financial institution 140. In some embodiments, lender 129 may request and borrower 128 may agree to allow lender 129 to place a pre-authorization hold on one or more existing credit accounts associated with borrower 150 (i.e., borrower collateral issuing financial institution 150) for a previously agreed upon amount and a previously agreed upon period. In some embodiments, the particular period during which the pre-authorization hold may be placed on one or more existing accounts may be dependent on a particular revolving credit account and/or the issuing financial institution (e.g., borrower collateral issuing financial institution 150). In some embodiments, an example the pre-authorization hold period may be less than or equal to a month. For example, borrower 128 may allow a pre-authorization hold for a period not exceeding a month. In some embodiments, the previously agreed upon hold amount may be equal to a periodic payment amount, remaining loan balance, and/or other amount agreed upon between borrower 128 and lender 129. In some embodiments, the pre-authorization hold may be recurring. For example, upon the expiration of the pre-authorization period associated with a first pre-authorization hold, a second pre-authorization hold may be placed, and so on. In some embodiments, the pre-authorization hold amount may change during each subsequent pre-authorization period. For example, a first pre-authorization hold amount may be equal to the loan amount and a second pre-authorization hold amount may be equal to a reduced loan balance (i.e., loan balance after the application of a periodic payment amount). For example, the borrower 128 may be offered a loan for $10,000 under repayment terms that require monthly $150 payments. Next, borrower 128 may agree to a pre-authorization hold for a 29 day period hold in the amount equal to $10,000 during the first pre-authorization period. During the second pre-authorization period, borrower 128 may agree to a $9,950 pre-authorization hold (i.e., loan balance after the application of a periodic payment of $150), and so on.

Lender acquiring financial institution 140 may send pre-authorization data including authorization amount and pre-authorization period in a pre-authorization message to a payment network, whereupon the payment network sends advisement to lender acquiring financial institution 140 and borrower collateral issuing financial institution 150. Borrower issuing financial institution 145 can place the hold on the funds equal to the pre-authorization amount by making those funds unavailable to borrower 128. In some embodiments, the payment network, using, e.g., an application programming interface (API), may place the pre-authorization. For example, a lender acquiring financial instruction 140 and borrower collateral issuing financial institution 150 may use a payment platform such Authorize.Net or similar platforms to process the pre-authorization.

Upon receiving the periodic payment by the lender acquiring financial institution 140, pre-authorization component 112 may be configured to remove the pre-authorization hold such that lender acquiring financial institution 140 may send a pre-authorization cancellation request to a payment network, whereupon the payment network sends advisement to lender acquiring financial institution 140 and borrower collateral financial institution 150 and removes the pre-authorization.

In some embodiments, unsecured loan platform 120 may be configured to process the pre-authorization as a payment in the event the periodic payment, as described above, cannot be processed. For example, default component 114 may be configured to process the pre-authorization. For example, lender acquiring financial institution 140 may send clearing data in a clearing message to the payment network, whereupon the payment network calculates a net settlement position and sends advisement to lender acquiring financial institution 140 and borrower collateral financial institution 150. Borrower collateral financial institution 150 can remit payment to the lender acquiring financial institution 140. Lender acquiring financial institution 140 then pays lender 130 for the periodic payment made by borrower 128, and borrower collateral financial institution 150 raises the balance borrower 128 has with collateral financial institution 150 (e.g., amount owed) by the amount of the periodic payment.

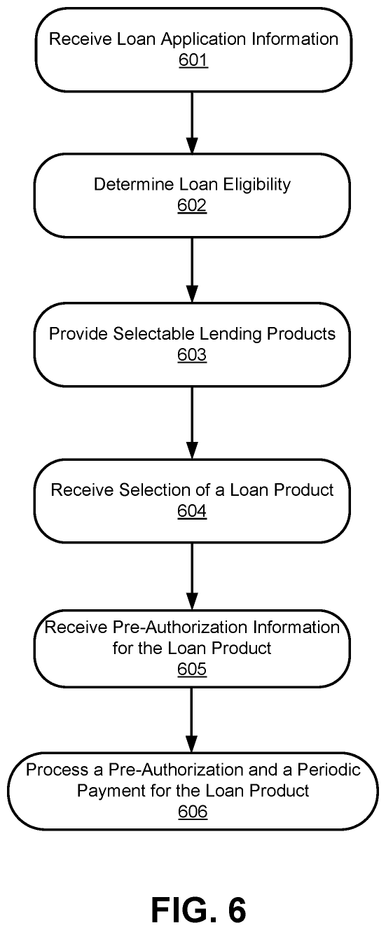

FIG. 6 illustrates a flow chart describing various processes that can be performed in order to manage an unsecured loan by an unsecured lending system in accordance with another embodiment. For example, at operation 601, loan application information may be received. The loan information may be used to determine borrower's eligibility for an unsecured loan, at operation 602.

Upon determining that the borrower is eligible for an unsecured loan, the borrower may be provided with selectable lending products, at operation 603. At operation 604, the borrower's selection of the unsecured lending product may be received including periodic payment amount and information related to borrower's issuing financial institution. At an operation 605, the borrower's pre-authorization information is received including information related to borrower collateral financial institution. At an operation 605, the pre-authorization and the periodic payment may be processed in accordance with the information received by operations 604, 605.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The described operations, such as those illustrated in FIGS. 1-6 and described above, may be accomplished using some or all of the system components described in detail herein and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting. It is to be expressly understood that the drawings are for the purpose of illustration and description only and are not intended as a definition of the limits of the invention.

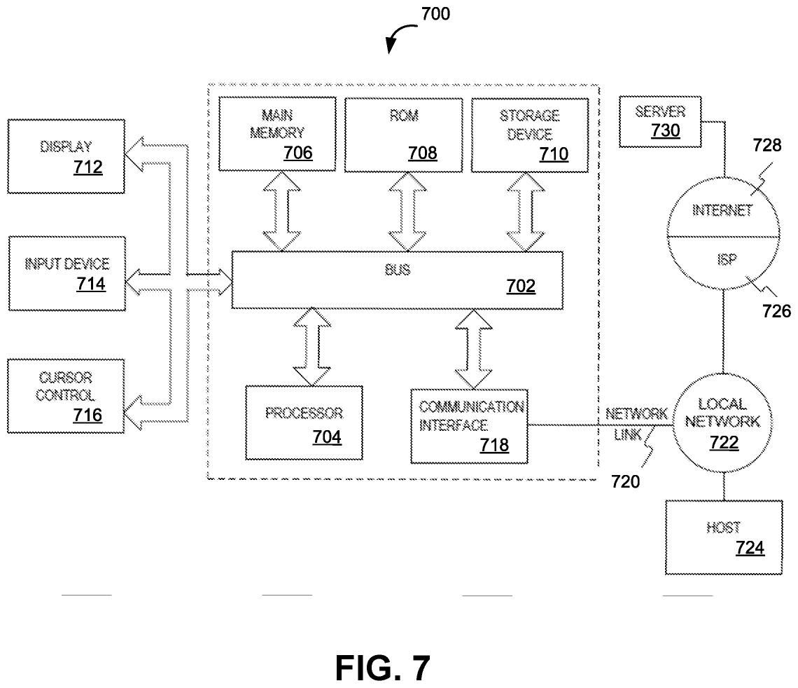

FIG. 7 depicts a block diagram of an example computer system in which any of the embodiments described herein may be implemented. The various components illustrated in FIGS. 1-6 may be implemented according to the computer system 700. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 700 may include a user interface component to implement a GUI that may be stored in a mass storage device as executable software codes that are executed by the computing device(s). This and other components may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicate with a WAN). Wireless links may also be implemented. In any such implementation, communication interface 718 sends and receives electrical, electromagnetic or optical signals that carry digital data streams representing various types of information.

A network link 720 typically provides data communication through one or more networks to other data devices. For example, a network link may provide a connection through local network to a host computer 724 or to data equipment operated by an Internet Service Provider (ISP) 726. The ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server 730 might transmit a requested code for an application program through the Internet 728, the ISP 726, the local network 722 and the communication interface 718. The received code may be executed by processor 704 as it is received, and/or stored in storage device 710, or other non-volatile storage for later execution.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for managing program participation requests, the system comprising: one or more processors configured by machine-readable instructions to:
receive, via a program participation application, a program participation request from a user, the program participation request specifying a set of user-specific parameters comprising user information and user request information;
receive, via the program participation application, a set of program eligibility parameters set by a program owner from a parameter database based on the set of user information and the user request information;
determine program eligibility based on the user information, the user request information, and the set of program parameters; and
transmit to the user, via the program eligibility application, a set of program participation requirements set by a program owner;
wherein the set of program participation requirements must be accepted by the user prior to enrolling in a program.

2. The system of claim 1, further comprising transmitting, via the program participation application, a response message approving the program participation request upon the program edibility determination indicating the user is eligible to participate in the program.

3. The system of claim 1, further comprising transmitting, via the program participation application, a response message declining the program participation request upon the program edibility determination indicating the user is not eligible to participate in the program.

4. The system of claim 1, wherein the set of program eligibility parameters comprise at least one of a minimum credit bureau score associated with the user.

5. The system in claim 4, wherein the credit bureau score is received by obtaining a credit bureau report using the information of the user.

6. The system in claim 1, wherein the user request information of the program participation request comprises at least one of a loan amount.

7. The system of claim 2, further comprising receiving an enrollment request form the user upon transmitting the response message approving the program participation request.

8. The system of claim 7, further comprising enrolling the user in the program, via the program participation application, upon receiving the enrollment request, wherein the set of program participation requirements have be accepted by the user.

9. The system of claim 1, wherein the set of program participation requirements comprise at least one of a credit line authorization the user agrees to use as a modified collateral.

10. The system of claim 8, further comprising receiving a set of program participation actions from the user, via the program the program eligibility application, subsequent to the enrollment of the user in the program;
wherein program participation actions are specified by the program participation requirements.

11. The system of claim 10, further comprising determining program participation success or failure based on the set of user participation action complying with the program actions specified by the program participation requirements.

12. The system of claim 11 Error! Reference source not found., further comprising transmitting a hold request upon determining the program participation failure, wherein the hold request comprises using the credit line authorization within the program participation requirements accepted by the user prior to enrolling in the program.

13. A method for managing program participation requests, the method comprising:
receiving, via a program participation application, a program participation request from a user, the program participation request specifying a set of user-specific parameters comprising user information and user request information;
receiving, via the program participation application, a set of program eligibility parameters set by a program owner from a parameter database based on the set of user information and the user request information;
determining program eligibility based on the user information, the user request information, and the set of program parameters;
transmitting to the user, via the program eligibility application, a set of program participation requirements set by a program owner; and
transmitting, via the program participation application, a response message approving the program participation request upon the program edibility determination indicating the user is eligible to participate in the program
wherein the set of program participation requirements must be accepted by the user prior to enrolling in a program.

14. The method of claim 13, wherein the set of program eligibility parameters comprise at least one of a minimum credit bureau score associated with the user.

15. The method of claim 14, further comprising receiving an enrollment request form the user upon transmitting the response message approving the program participation request.

16. The method of claim 13, further comprising enrolling the user in the program, via the program participation application, upon receiving the enrollment request, wherein the set of program participation requirements have be accepted by the user.

17. The method of claim 13, wherein the set of program participation requirements comprise at least one of a credit line authorization the user agrees to use as a modified collateral.

18. The method of claim 16, further comprising receiving a set of program participation actions from the user, via the program the program eligibility application, subsequent to the enrollment of the user in the program;
wherein program participation actions are specified by the program participation requirements.

19. The method of claim 18, further comprising determining program participation success or failure based on the set of user participation action complying with the program actions specified by the program participation requirements.

20. The method of claim 19, further comprising transmitting a hold request upon determining the program participation failure, wherein the hold request comprises using the credit line authorization within the program participation requirements accepted by the user prior to enrolling in the program.
